(19) United States
(12) Patent Application Publication
(10) Pub. No.: US 2011/0071874 A1
(43) Pub. Date: Mar. 24, 2011

(54) METHODS AND APPARATUS TO PERFORM CHOICE MODELING WITH SUBSTITUTABILITY DATA

(76) Inventors: Noemie Schneersohn, Paris (FR); Brian Robert Smith, II, Evanston, IL (US); John G. Wagner, Cincinnati, OH (US)

(21) Appl. No.: 12/887,027

(22) Filed: Sep. 21, 2010

Related U.S. Application Data
(60) Provisional application No. 61/244,242, filed on Sep. 21, 2009.

(51) Int. Cl. G06Q 30/00

(52) U.S. Cl. 705/7.32

(57) ABSTRACT

Methods and apparatus are disclosed to perform choice modeling with substitutability data. An example method includes receiving base choice probability values for a respondent, wherein the base choice probability value is associated with a product, receiving a respondent substitutability factor associated with the product, identifying, with a cluster analysis engine, a primary product and a secondary product and generating a subrespondent associated with the secondary product, and calculating, with a cross sourcing engine, a modified choice probability for the subrespondent for the secondary product based on the respondent substitutability factor and the base choice probability values associated with the secondary product.

### RELATED APPLICATION

This patent claims the benefit of U.S. Provisional Patent Application Ser. No. 61/244,242, which was filed on Sep. 21, 2009, and is hereby incorporated herein by reference in its entirety.

### FIELD OF THE DISCLOSURE

This disclosure relates generally to product market research, and, more particularly, to methods and apparatus to perform choice modeling with substitutability data.

### BACKGROUND

Choice modeling techniques allow market researchers to assess consumer behavior based on one or more stimuli. Consumer preference data is collected during the one or more stimuli, such as a virtual shopping trip in which consumers are presented with any number of selectable products (e.g., presented via a kiosk, computer screen, slides, etc.). The consumer preferences associated with products may be referred to as utilities, which may be the result of one or more attributes of the product. While choice modeling allows for the market researchers to predict how one or more consumers will respond to the stimuli, such analysis techniques typically assume that each item in a virtual shopping trip is equally substitutable to all other items available to the consumer.

### BRIEF DESCRIPTION OF THE DRAWINGS

FIG. 1 is a schematic illustration of an example substitutability simulation system.

FIG. 2 is a schematic illustration of an example substitutability manager shown in FIG. 1.

FIGS. 3, 9, 15 and 16 are example flowcharts that may be used with the substitutability simulation system of FIG. 1.

FIG. 4 is an example choice probability index chart generated by the substitutability simulation system of FIG. 1.

FIG. 5 is an example price index chart generated by the substitutability simulation system of FIG. 1.

FIG. 6 is an example category sourcing chart generated by the substitutability simulation system of FIG. 1.

FIGS. 7 and 8 are example choice probability charts generated by the substitutability simulation system of FIG. 1.

FIG. 10 is an example card sort screenshot facilitated by the substitutability simulation system of FIG. 1.

FIGS. 11-14 are example multidimensional scaling output charts generated by the substitutability simulation system of FIG. 1.

FIG. 17 is an example substitutability choice probability calculation performed by the substitutability simulation system of FIG. 1.

FIG. 18 is a schematic illustration of an example processor platform that may execute the instructions of FIGS. 3, 9, 15 and 16 to implement any or all of the example methods, systems and apparatus described herein.

### DETAILED DESCRIPTION

Methods and apparatus are disclosed to perform choice modeling with substitutability data. An example method includes receiving base choice probability values for a respondent, wherein the base choice probability value is associated with a product, receiving a respondent substitutability factor associated with the product, identifying, with a cluster analysis engine, a primary product and a secondary product and generating a subrespondent associated with the secondary product, and calculating, with a cross sourcing engine, a modified choice probability for the subrespondent for the secondary product based on the respondent substitutability factor and the base choice probability values associated with the secondary product.

Market researchers, product promoters, marketing employees, agents, and/or other people and/or organizations chartered with the responsibility of product management (hereinafter collectively referred to as “sales forecasters,” or “clients”) typically attempt to justify informal and/or influential marketing decisions using one or more techniques to predict sales of one or more products of interest. Accurate forecasting models are useful to facilitate these decisions. In some circumstances, a product may be evaluated by one or more research panelists/respondents, which are generally selected based upon techniques having a statistically significant confidence level that such respondents accurately reflect a given demographic of interest. Techniques to allow respondents to evaluate a product, which allows the sales forecasters to collect valuable choice data, include focus groups and/or purchasing simulations that allow the respondents to view product concepts (e.g., providing images of products on a monitor, asking respondents whether they would purchase the products, discrete choice exercises, etc.). The methods and apparatus described herein include, in part, one or more modeling techniques to facilitate sales forecasting and allow sales forecasters to execute informed marketing decisions. The one or more modeling techniques described herein may operate with one or more modeling techniques, consumer behavior modeling, and/or choice modeling.

Generally speaking, choice modeling is a method to model a decision process of an individual in a particular context. Choice models may predict how individuals will react in different situations (e.g., what happens to demand for product A when the price of product B increases/decreases?). Predictions with choice models may be made over large numbers of scenarios within the context and are based on the concept that people choose between available alternatives in view of one or more attributes of the products. For example, when presented with a choice to take a car or bus to get to work, the alternative choices may be divided into three example attributes: price, time and convenience. For each attribute, a range of possible levels may be defined, such as three levels of price (e.g., $0.50, $1.00 or $1.50), two levels of time (e.g., 5 minutes or 20 minutes, corresponding to two attributes of “convenient” or “not-convenient,” respectively). In the event a transportation mode exists that is cheapest, takes the least amount of time and is most convenient, then that transportation mode is likely to be selected. However, tradeoffs exist that cause a consumer to make choices, in which some consumers place greater weight on some attributes over others. For some consumers, convenience is so important that the price has little effect on the choice, while other consumers are strongly motivated by price and will suffer greater inconvenience to acquire the lowest price.

In the context of store, retail, wholesale purchases, clients may wish to model how a consumer chooses among the products available. Alternatives may be decomposed into attributes including, but not limited to product price, product display, or a temporary price reduction (TPR), such as an in-store marketing promotion that price the product lower than its base price. Although the methods and apparatus described herein include price, display and/or TPR, any other attributes may be considered, without limitation. Additional or alternative attributes may include brand or variety. When making a purchase decision, consumers balance the attributes, such as brand preferences balanced with the price and their attraction for displays and/or TPRs, thereby choosing the product that maximizes their overall preference.

The methods and apparatus described herein may optimize a launch or restage strategy to optimize pricing strategies and/or portfolio management. As preferences of each respondent are estimated for each attribute's level of a product, analysts can simulate different choice scenarios and determine one or more that enables its client(s) to maximize choice probability and/or revenue potential.

Discrete choice exercises are frequently used with choice modeling techniques to determine consumer preference data related to one or more products of interest. Products have one or more associated consumer preferences (sometimes referred to herein as “utilities”), in which the product utility values may differ from each other. Such utilities may be the result of one or more attributes of the product and purchasing behavior of consumers depends on, in part, what other products may be considered as viable substitutes to a product of interest. Based on estimated utilities, one or more choice probabilities may be calculated to develop one or more discrete choice models and/or choice modeling exercises that enable the sales forecaster to calculate choice shares, thereby revealing consumer behavior in view of varying availability of one or more substitutes to the product of interest.

Choice share calculation may allow risk evaluation and/or opportunities during product launch efforts. Such evaluation is particularly noteworthy in view of the fact that approximately 10% of new products are still in the market after one year. While choice modeling allows clients to identify marketing opportunities, marketing issues and/or forecasting, logit techniques assume that other available products are 100% substitutable to a candidate alternative product. Similarly, nested logit techniques assume 100% substitutability within nests, in which an analyst typically provides one or more alternative assumptions. Probit techniques, on the other hand, do not make the assumption that all other products are 100% substitutable. In the event the client wishes to analyze multi-category markets, in which alternative available products are not necessarily 100% substitutable, then choice modeling does not provide an accurate result of risk and/or opportunity associated with a particular product.

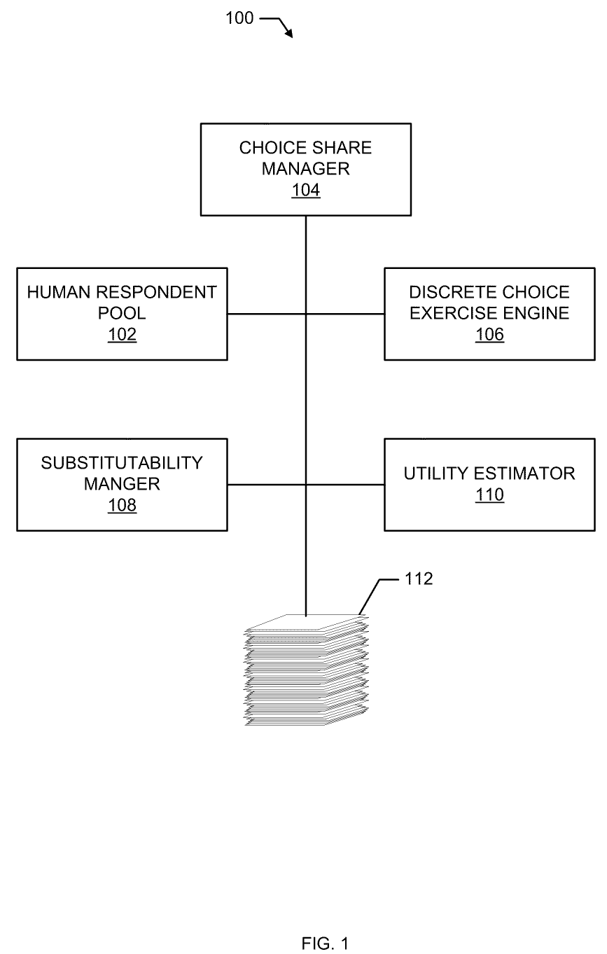

FIG. 1 is a schematic illustration of an example substitutability simulation system 100, which includes a human respondent pool 102. The example human respondent pool 102 may include any number of panelist groupings/sets related to any number of demographic(s) of interest and/or to any number of geographies of interest. Such panelists and/or sets of panelists are human participants to one or more virtual shopping trips that, in part, provide data to allow utility values to be calculated for one or more products. Such panelists may operate as respondents and be selected based on a statistical grouping to allow projection to a larger universe of similar consumers and/or a larger universe of households. Generally speaking, a respondent is a human being that responds to questions in, for example, a choice exercise.

The example substitutability simulation system 100 includes a choice share manager 104 communicatively connected to a discrete choice exercise engine 106, the human respondent pool 102, a substitutability manager 108 and a utility estimator 110. The example choice share manager 104 invokes one or more services of the human respondent pool 102, the discrete choice exercise engine 106, the substitutability manager 108 and/or the utility estimator 110 to generate simulation output 112. Generally speaking, the example discrete choice exercise engine 106 obtains choice data from the human respondents of the example respondent pool 102. The utility estimator 110, in part, estimates corresponding utility values for one or more products of interest based on choice data obtained from the human respondents. As described in further detail below, the example substitutability manager 108 facilitates methods to, in part, perform choice modeling with substitutability data.

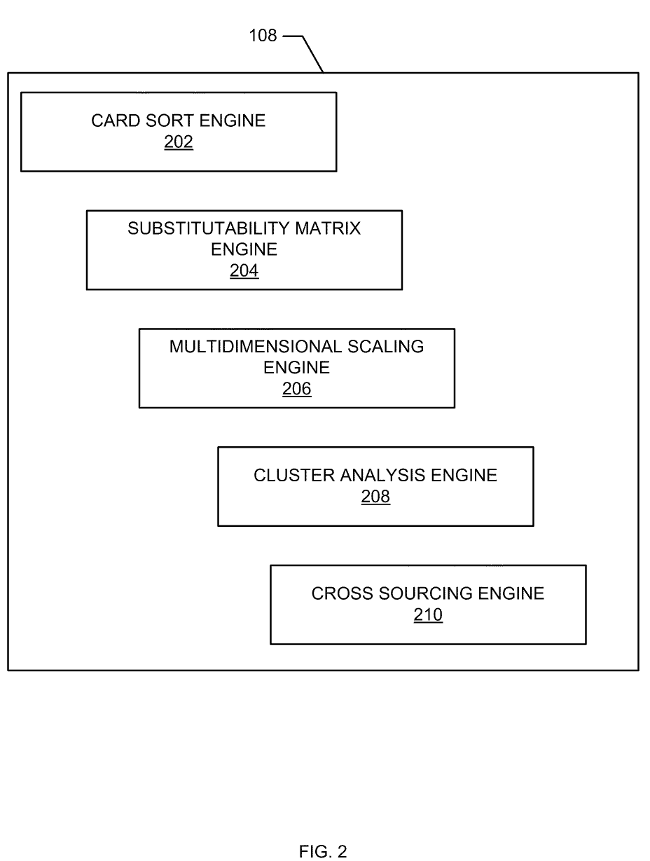

FIG. 2 is a schematic illustration of the example substitutability manager 108 of FIG. 1. In the illustrated example of FIG. 2, the substitutability manager 108 includes a card sort engine 202 to facilitate collection of substitutability information from respondents, and a substitutability matrix engine 204 to represent a similarity proximity between pairs of products, as described in further detail below. Briefly, the example card sort engine facilitates one or more sorting exercises to be performed by panelists that obtains information indicative of similarity between products. The sorting exercises are free-form, thereby allowing the panelist to select any number of products deemed similar and placed in a group. Output from the example card sort engine is described in further detail below. The example substitutability manager 108 also includes a multidimensional scaling (MDS) engine 206 to create one or more maps of the products based on the proximities between the items in terms of substitutability. The more substitutable two items are to each other, the closer they will be placed on a map, as described in further detail below. Additionally, the example substitutability manager 108 includes a cluster analysis engine 208 to identify groups/clusters of products that are deemed similar to the respondents, and a cross sourcing engine 210, also described in further detail below.

In operation, the example substitutability simulation system 100 defines a category of products of interest to study and determines one or more marketing issues to resolve. Products (e.g., stock keeping units (SKU)) are selected to be shown to the respondents via the example discrete choice exercise engine 106 so that they may analyze the alternatives to make a virtual purchasing decision. Based on those purchasing decisions, a behavioral model is developed to estimate preferences (utilities) of respondents for each level of each attribute. Experiment attributes are designed, such as modifying the price, the presence of a display and/or a TPR change for the SKUs. As described in further detail below, experiment design may include efforts to maintain design rules of balance, orthogonality and tradeoff. However, in other examples, some design rules are modified to allow a reasonable number of sets for evaluation and to more closely align with in-store shopping habits. The example substitutability simulation system 100 also facilitates data collection, such as exposing the respondents to benefit statements of products to draw awareness to the new products. Virtual shopping trips are used in some examples in which the respondent selects from a range of products from one or more categories. Estimation of utilities for each level of each attribute is performed by the substitutability simulation system 100 using, for example, a Hierarchical Bayes (HB) methodology before using the utilities in a simulator to simulate different scenarios and observe one or more results. Additionally or alternatively, HB methodologies may be replaced with other techniques to estimate utilities.

While an example manner of implementing the substitutability simulation system 100 of FIG. 1 has been illustrated in FIGS. 1 and 2, one or more of the elements, processes and/or devices illustrated in FIGS. 1 and 2 may be combined, divided, re-arranged, omitted, eliminated and/or implemented in any other way. Further, the example choice share manager 104, the example discrete choice exercise engine 106, the example substitutability manager 108, the example utility estimator 110, the example card sort engine 202, the example substitutability matrix engine 204, the example multidimensional scaling engine 206, the example cluster analysis engine 208, and/or the example cross sourcing engine 210 of FIGS. 1 and 2 may be implemented by hardware, software, firmware and/or any combination of hardware, software and/or firmware. Thus, for example, any of the example choice share manager 104, the example discrete choice exercise engine 106, the example substitutability manager 108, the example utility estimator 110, the example card sort engine 202, the example substitutability matrix engine 204, the example multidimensional scaling engine 206, the example cluster analysis engine 208, and/or the example cross sourcing engine 210 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the example choice share manager 104, the example discrete choice exercise engine 106, the example substitutability manager 108, the example utility estimator 110, the example card sort engine 202, the example substitutability matrix engine 204, the example multidimensional scaling engine 206, the example cluster analysis engine 208, and/or the example cross sourcing engine 210 are hereby expressly defined to include a computer readable medium such as a memory, DVD, CD, etc. storing the software and/or firmware. Further still, the example choice share manager 104, the example discrete choice exercise engine 106, the example substitutability manager 108, the example utility estimator 110, the example card sort engine 202, the example substitutability matrix engine 204, the example multidimensional scaling engine 206, the example cluster analysis engine 208, and/or the example cross sourcing engine 210 of FIGS. 1 and 2 may include one or more elements, processes and/or devices in addition to, or instead of, those illustrated in FIGS. 1 and 2, and/or may include more than one of any or all of the illustrated elements, processes and devices.

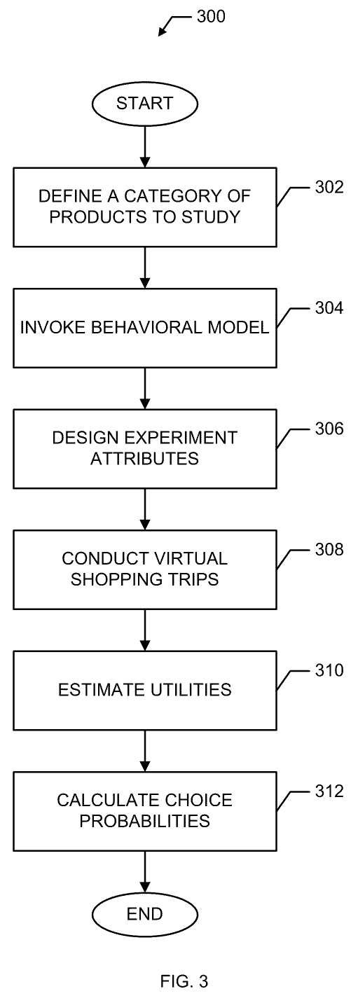

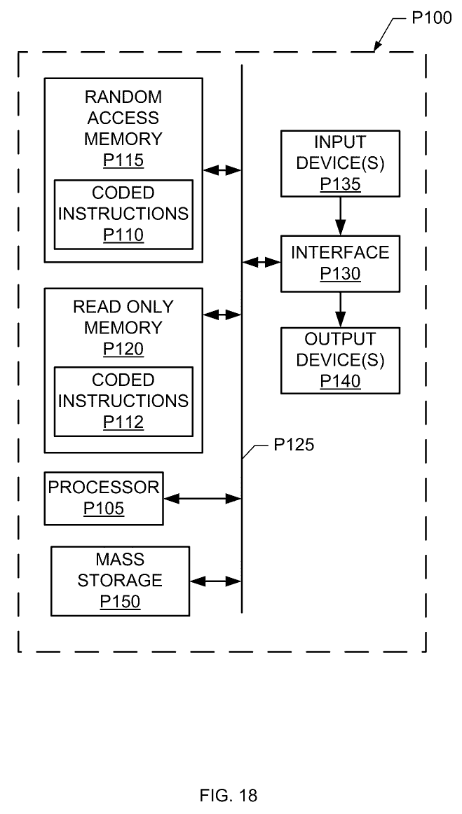

A flowchart representative of example machine readable instructions for implementing the substitutability simulation system 100 of FIG. 1 is shown in FIG. 3. In this example, the machine readable instructions comprise a program for execution by a processor such as the processor P105 shown in the example computer P100 discussed below in connection with FIG. 18. The program may be embodied in software stored on a computer readable medium such as a CD-ROM, a floppy disk, a hard drive, a digital versatile disk (DVD), or a memory associated with the processor P105, but the entire program and/or parts thereof could alternatively be executed by a device other than the processor P105 and/or embodied in firmware or dedicated hardware. Further, although the example program is described with reference to the flowchart illustrated in FIG. 3, many other methods of implementing the example substitutability simulation system 100 may alternatively be used. For example, the order of execution of the blocks may be changed, and/or some of the blocks described may be changed, eliminated, or combined.

As mentioned above, the example processes of FIGS. 3, 9, 15 and 16 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 3, 9, 15 and 16 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

The program of FIG. 3 to perform general choice modeling 300 begins at block 302 in which the example choice share manager 104 defines a category of products to study. As described above, products and/or SKUs are selected to be shown to the respondents and the respondents are allowed to analyze all the alternatives to make their decision(s). In an effort to prevent respondent boredom and/or choice fatigue, the number of products may be limited to any selected value such as, for example, 100 products. However, any other number of products may be selected to maintain statistical significance and/or to align with actual shopping trip expectations. When consumers are in a store and want to buy a product, the consumers often have to choose among a large number of items. As such, analysts attempt to balance the number of items on the shelves with the representation of the true market experience. In some examples, analysts put products having the largest market share on shelves to represent approximately 70% to 80% of the market. Additionally, products selected for study (block 302) also require a selection of corresponding attributes or variables to be analyzed. In some examples, attributes include the SKU, the price, the presence or absence of a display, and/or a TPR.

To obtain an estimation of how well each product will perform (e.g., number of units sold, preference of the product over other products, etc.) in the market when compared to other products in the market, the example choice share manager 104 invokes a behavioral model (block 304). In some examples, an additive model may be employed that uses utilities of each respondent for each attribute level to calculate a utility of the respondent for each alternative. Each one of the attributes' levels may be added to represent alternatives as the sum of their attributes, also referred to as the compensatory effect. For example, three SKUs (A, B and C) having corresponding prices P can either be on display (D=true) or not on display (D=false). Additionally, each SKU may either have a TPR (TPR=true) or not have a TPR (TPR=false). Each SKU is treated as an attribute that has 3 attributes of its own, for which three utilities will be created for each respondent, one for each level (u_{A}, u_{B} and u_{C}). For price (P), display (D) and TPR, there are no utility levels, just one value that describes how a respondent reacts to a difference in P, D or TPR. Using an additive model, the utility of one respondent for alternative A (e.g., product A at the price P having a display D and a TPR) may be represented as shown in Equation 1.

U_{A}=uA+U_{P}·P+U_{D}·Display+U_{TPR}·TPR Equation 1.

To calculate choice probabilities, which represents the probability of a respondent to choose a given alternative, a model is selected. In some examples, a Multinomial Logit (MNL) model is used to reveal the probability of the respondent to choose alternative A, as shown in Equation 2.

$$P ( A ) = \frac{{e}^{{U}_{A}}}{{e}^{{U}_{A}} + {e}^{{U}_{B}} + {e}^{{U}_{C}}} . \qquad Equation 2$$

After calculating choice probabilities for each respondent for each alternative, they are averaged to obtain an aggregated choice probability for each product.

The general choice modeling process 300 also includes designing experiment attributes (block 306). When each respondent makes several choices, the choice information reveals some logic behind those choices because each set of alternatives has the same SKU, but the attributes chosen are different (e.g., price, presence of a display, TPR, etc.). Causing the attributes to vary help reveal cause and effect. The price attribute value varies around the base price value for all the products. Generating one or more sets of alternatives of attribute value combinations results in the experiment that ultimately reveals the underlying preferences of the respondents.

Typically, the experiment will maintain rules related to balance, orthogonality and tradeoff. An experimental design is balanced when each attribute's level is shown the same number of times to each respondent. In some examples, not all SKUs have a display attribute as true, thus most choice probability experiments are not completely balanced. Much like true market experiences that consumers will have, most SKUs do not have a corresponding display and there will be a greater number of SKUs without the display attribute set to true.

An experimental design is orthogonal when each level of one attribute appears the same number of times with each level of another attribute. For example, if there are three sets of alternatives showing product A on display, but without a TPR, then there should be also three sets of alternatives showing product A on display and with a TPR, three others with product A not on display and without a TPR, and three more with product A not on display, but with a TPR. Of course, TPR is a type of attribute that does not necessarily fit well within rules aimed at maintaining orthogonality because, in part, TPR is true when the price is equal to or less than the base price of the product.

An experimental design illustrates tradeoff when respondents are forced to make a decision on a single attribute. As such, traditional notions of proper experimental tradeoff suggest that two levels of two different attributes should not be shown together. For example, if a product is always on display when it has a TPR, then there is no explicit tradeoff between attraction to the display as distinguished from attraction to the TPR.

In view of the conflicts during one or more attempts to maintain traditional notions of balance, orthogonality and tradeoff, the methods and apparatus described herein go against such rules of experimental design to facilitate a manageable number of sets and employ a more realistic experience. In effect, the methods and apparatus described herein obtain responses from the respondents that more closely align to in-store shopping habits and experiences.

The general choice modeling process 300 also includes conducting virtual shopping trips (block 308). A number of products are shown multiple times to each respondent, in which one or more attributes of the products change during each instance of viewing. In some examples, a sample of respondents is pulled out of a panel, such as names of respondents from the human respondent pool 102. Each respondent is shown a benefit statement of some (or all) of the products in the virtual shopping trip, in which the statement includes a few sentences that describe the concept of the product and are shown together with a picture of the product. At least one purpose of the benefit statement is to draw awareness to new products. Without a benefit statement, awareness for existing products would be much higher than for the new products. However, if benefit statements are shown only for new products, then bias may become an issue that favors those new products over existing products. As a result, the example substitutability simulation system displays benefit statements for all the new products and some of the existing products so that the respondents are aware of all products, which is sometimes referred to as the “100% awareness” hypothesis.

During the virtual shopping trips (block 308), each respondent goes through a number of shopping trip exercises (e.g., 12), in which each shopping trip displays a shelf with a range of products from one category. Shelves are organized in a manner to reflect what the respondent would see if at a retail store. Prior to each shopping trip, a screen is shown to the respondent to remind him/her that each “trip” to the store is a separate shopping experience in which he/she is to act as if they are running out of the category presented. When looking at the shelf, the respondent can zoom into the shelf for a closer view of each product, such as by clicking on the product to obtain a close-up view. To make a purchase, the respondent clicks on the product to see the close-up picture before confirming the purchase, which minimizes circumstances where the respondent chooses random products in a rushed manner. As described in further detail below, one or more virtual shopping trips (block 308) may be performed in a manner that facilitates choice modeling with substitutability data.

The general choice modeling process 300 also includes estimating utilities (block 310). Estimation of utilities is performed for each level of each attribute at a respondent level using the Hierarchical Bayes methodology. Generally speaking, the Hierarchical Bayes methodology creates individual-level models without a need to have more choice tasks per respondent than the number of parameters to estimate. Hierarchical Bayes methods leverage information from all respondents to estimate results for each individual, in which the individual-level utilities may be estimated by a statistical simulation technique called Gibbs Sampling. Gibbs Sampling combines the responses of the entire sample with the responses of the individual to generate a distribution of possible utility values for each respondent. The mean of the distributions may be used as the final estimates for the utilities.

The general choice modeling process 300 also includes calculating choice probabilities (block 312). After estimating all the utilities (block 310), they are loaded in a simulator to simulate one or more different scenarios so that corresponding results may be observed. Scenarios may include, but are not limited to changing price, availability, the presence of a display or a TPR, simulating a restage, and/or simulating the presence or absence of one or more competitors and/or sizes. The simulator may use, for example, a multinomial logit model, a nested logit model, or a probit model to calculate the choice probabilities of the products. The results of the example general choice modeling process 300 allow one or more marketing issues to be investigated and provides choice probability indices for one or more products in one of more different marketing situations.

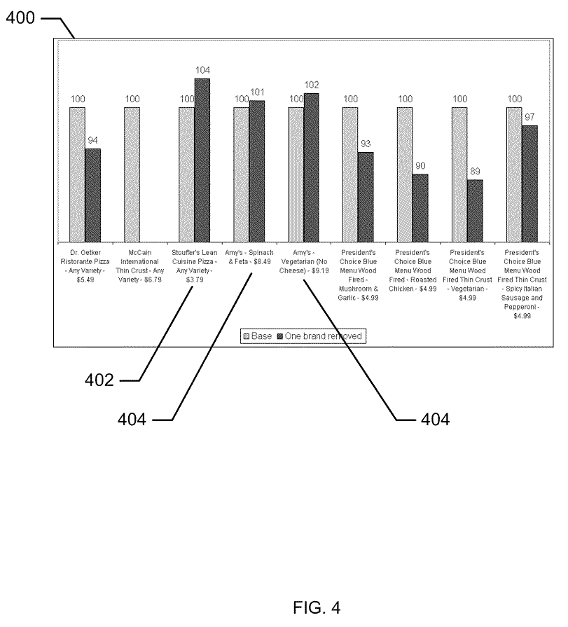

For example, the general choice modeling process 300 may generate a choice probability index chart as shown in FIG. 4. The example choice probability index chart 400 of FIG. 4 represents the choice probability index values of some selected brands of interest for two different market scenarios. A first scenario serves as a reference, thus all the price index values for this scenario are set to 100. The chart 400 illustrates an evolution of choice probabilities by brand when a characteristic of the market is changed. One deliverable of value to a client of the example substitutability simulation system 100 is that a decision may be made related to whether attribute changes should be made to one or more products (e.g., should a TPR be added to the product, should the price of the product be raised/lowered, etc.).

The example chart 400 of FIG. 4 illustrates an evolution of choice probabilities for brands of pizza when one brand of interest (i.e., McCain International Thin Crust Pizza) is removed from the market. In the event that McCain International Thin Crust Pizza is removed from the market, most of the remaining brands of interest will experience a decreased choice probability value, except for two brands. In particular, Stouffer's Lean Cuisine Pizza 402 and Amy's 404 brands experience an increase in their corresponding choice probability values.

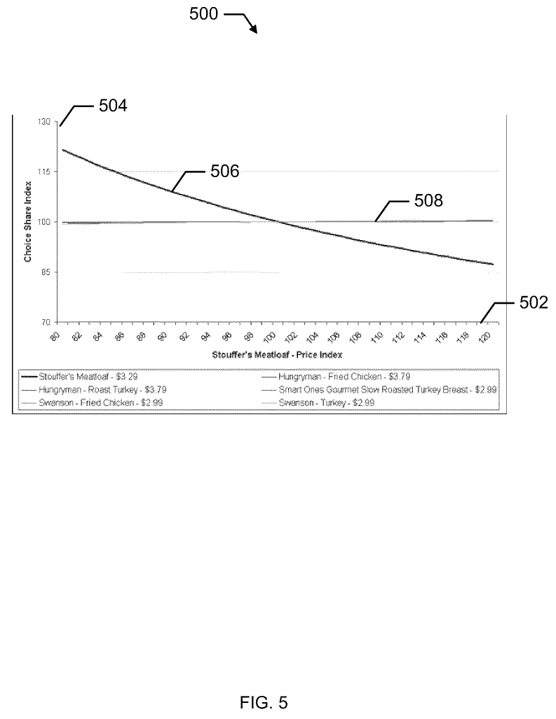

Another marketing issue of interest to clients using the example substitutability simulation system 100 includes effects of pricing strategy. In the illustrated example of FIG. 5, a price index chart 500 includes an x-axis representing price index 502, a y-axis representing choice share index 504, and a curve representing the effects of Stouffer's Meatloaf during price changes (curve 506). Additionally, the example price index chart 500 includes a curve representing the effects on other brands (overlapping) during price changes (curve 508). As shown by curve 506, the choice probability of Stouffer's Meatloaf decreases as the price increases, but the other brands (curve 508) maintain a relatively unchanging choice share index value. In other words, a client's proposed pricing strategy is illustrated in the example price index chart 500 to assist the client in deciding whether or not to increase price and/or to establish a threshold price increase/decrease value to maintain a degree of competitiveness with other brands.

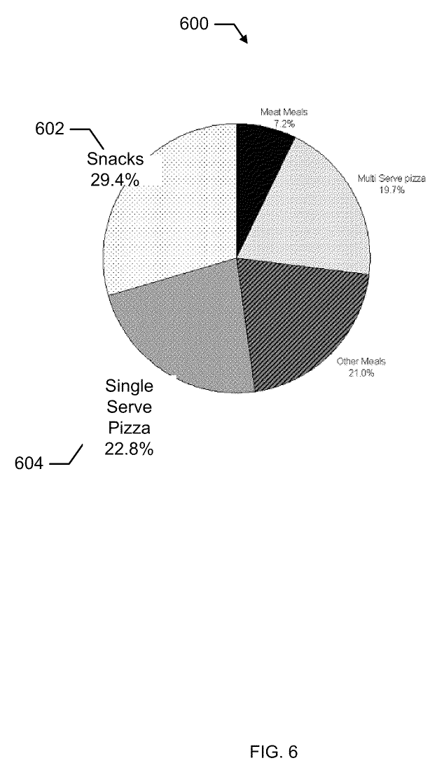

Yet another marketing issue of interest to clients using the example substitutability simulation system 100 includes identifying the effects of marketing strategies on sourcing behavior. When a new product comes to the market, it diverts consumers from an existing product, and the methods and apparatus described herein help to illustrate whether consumers are diverted from competitor brands, or the same brand as the new product. FIG. 6 is an example chart 600 showing which categories of food are sourced from McCain Pizza Pockets. In the illustrated example of FIG. 6, snacks 602 and single serve pizza 604 are most affected by the introduction of McCain Pizza Pockets.

While the general choice modeling process 300 allows one or more clients to obtain valuable marketing insight, use of the Multinomial Logit model suffers from a limitation related to assumptions that all SKUs shown in the virtual shopping trips are perfect substitutes for an unavailable product. As such, the methods and apparatus described herein enhance the example general choice modeling process 300 in a manner to accommodate for the fact that not all products shown to the respondents are 100% substitutable to a product that is not available during one or more shopping trips.

One issue associated with the Multinomial Logit (MNL) model includes a hypothesis that all the alternatives when making a choice are equally substitutable to each other, which is sometimes referred to as the Independence of Irrelevant Alternatives (IIA) hypothesis. The IIA hypothesis is a function of the manner in which choice probabilities are calculated with the MNL model. As described above in view of Equation 1, U_{A}, U_{B}, and U_{C} are the utilities of alternatives (e.g., products) A, B and C, respectively. Equation 3 illustrates a ratio of the probability of choosing A to the probability of choosing B.

$$\frac{P ( A )}{P ( B )} = \frac{{e}^{{U}_{A}}}{{e}^{{U}_{B}}} . \qquad Equation 3$$

Example Equation 3 illustrates that the ratio of the probabilities is independent of the utilities of the other product available. For example, if the alternative product C is not available, then the probabilities of choosing the other alternatives (i.e., product A or B) will increase, but the ratio of these probabilities will not change. This means that any preference a consumer might have for a particular brand does not impact his preference for other brands within the same category. Accordingly, at least one downside of the IIA property is that an assumption exists that products A and B are equal substitutes for product C, which is not an accurate representation of the market and/or consumer behaviors within the market. For example, if product A is caffeinated coffee, and products B and C are decaffeinated coffee, then these two kinds of coffee are not substitutable for every respondent, despite being in the same general category of coffee. When the MNL model is applied to these three products, the model assumes that there is a perfect and equal substitutability between all the products for all of the respondents.

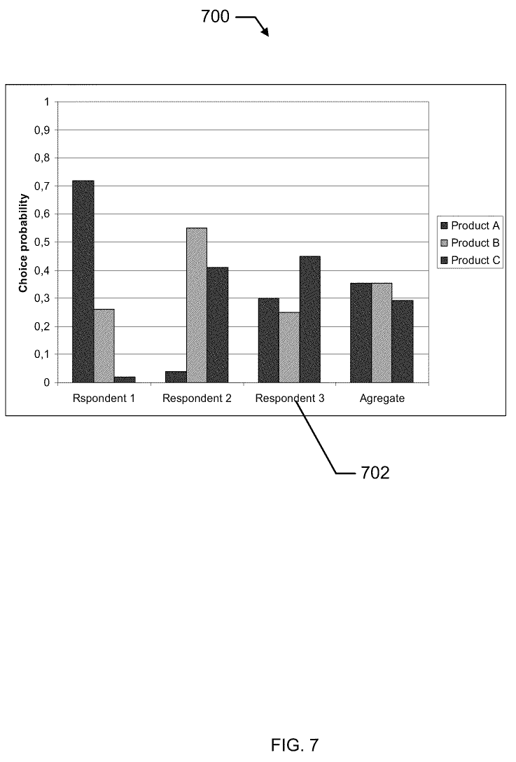

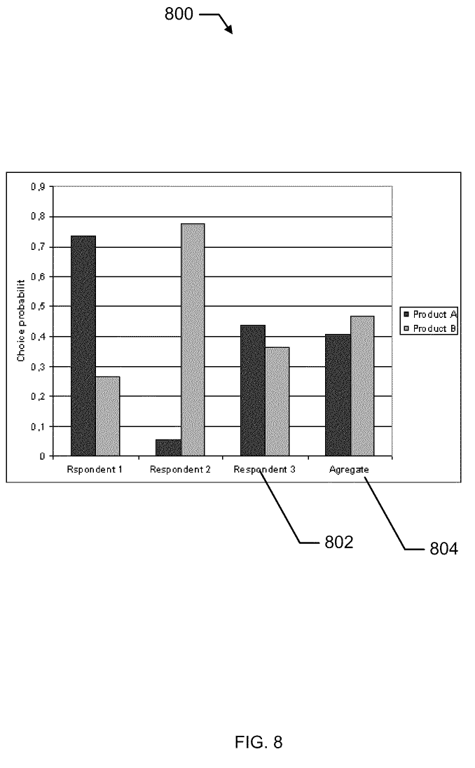

FIG. 7 is an example chart 700 showing three consumers having choice probabilities for three products (i.e., product A, B and C). Product A is caffeinated coffee, and products B and C are decaffeinated coffee. Example respondent 3 (702) has a preference for decaffeinated coffee product C. However, in the event that product C is no longer available for some reason, a consumer would likely transfer their probability of choosing product C to another decaffeinated coffee product, such as product B. The MNL model does not operate in this manner. Instead, when applying the MNL model to the aforementioned example, the example chart 800 of FIG. 8 illustrates that results do not follow logical expectations. In the illustrated example of FIG. 8, the probability that respondent 3 (802) chooses product B or C is much higher than the probability that product A is chosen. Intuitive expectations would be that product B would gain more choice probability than product A, but the MNL model results in the ratio of the choice probabilities of A to B staying the same due to the IIA hypothesis. While circumstances in which all products are perfect substitutes work well with the MNL model, the results in this example circumstance cannot be trusted.

The issue related to the IIA hypothesis is not visible at the aggregate level, as shown by the average of the respondents 804. When all the respondents' probabilities are aggregated, product B gains overall more of the choice probability of C than A does. The effect illustrates that the IIA issue can be hidden at the aggregate level. Although clients using the example general choice modeling process 300 would like to be able to have multi-category projects, the aforementioned limitations require that any choice modeling study using the MNL model must have perfect substitutes, otherwise individual level results may be untrustworthy. For example, a study of a diaper category may be severely limited by the MNL model when newborn diapers are placed on the same virtual shelf with toddler diapers, neither of which may be substituted for the other.

Traditional attempts to minimize these problems have required an analyst to employ their subjective opinions to which products are suitable for each virtual shelf, which places limitations on statistical repeatability, accuracy and legitimacy of the subcategories chosen by the analyst. The example methods and apparatus described herein employ the MNL model in a manner that overcomes inherent limitations related to substitutability. Additionally, the methods and apparatus described herein may employ a nested logit model, which incorporates groups of products (nests) such that, within each nest, 100% substitution can be assumed. Traditional approaches to using the nested logit model include at least one weakness based upon reliance of analysts to generate nests based on their subjective understanding of market products. In other words, analyst selections may be arbitrary rather than data-based. As described in further detail below, an example card sort may be implemented to group products based on data rather than analyst judgment when implementing one or more nested logit techniques.

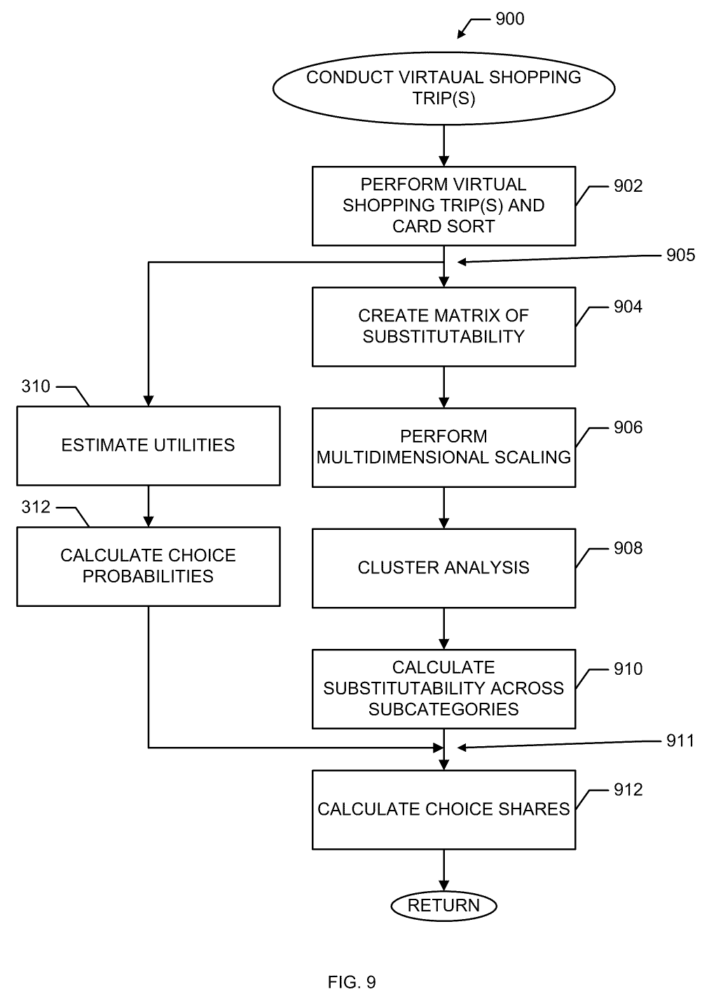

The methods and apparatus described herein augment the general choice modeling process 300 to address the aforementioned limitations of the MNL model when conducting a choice analysis study. FIG. 9 is an example program 900 to conduct virtual shopping trips. In operation, the example program 900 of FIG. 9 may be invoked, in whole or in part, at block 308 of FIG. 3.

In the illustrated example of FIG. 9, the program 900 includes invoking the example discrete choice exercise engine 106 to perform one or more virtual shopping trip(s) and invoking the example card sort engine 202 to perform a card sort activity with a respondent (block 902). The example program 900 may proceed in parallel (node 905) in which blocks 310 and 312 operate in parallel to blocks 904-910. The example process includes invoking the example substitutability matrix engine 204 to create a matrix of substitutability (block 904), invoking the example multidimensional scaling engine to perform a multidimensional scaling operation to create a map (block 906), invoking the example cluster analysis engine to analyze the map to perform a cluster analysis (block 908), and calculating a degree of substitutability across subcategories based on the distance between those subcategories (block 910). The example parallel paths of blocks 310, 312 with blocks 904-910 may converge at node 911 to calculate choice shares in view of substitutability information and baseline utilities and choice chare probability calculations. As described in further detail below, some examples may bypass multidimensional scaling operation(s) in view of one or more alternate techniques.

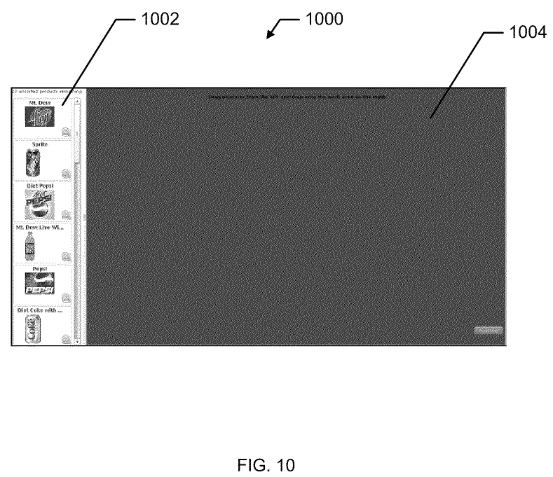

In operation, after performing one or more virtual shopping trips with the example discrete choice exercise engine 106, the example card sort engine 202 enables respondents to create groups of products (block 902). Turning briefly to FIG. 10, an example card sort screenshot 1000 includes an unsorted product list 1002 and a work area 1004. The product list 1002 contains all the products selected for a market study, from which respondents drag products from the list 1002 into groups in the work area 1004. While all the products may not be shown to all the respondents during one virtual shopping trip, after a number of virtual shopping trips all the respondents will be exposed to all the products. Respondents may create groups of products via drag-and-drop operations, in which the products within each group are deemed to be substitutable with each other. As described in further detail below, the data from the card sorting application is used to create subcategories of products that are substitutable to each other. Additionally, in some examples, the card sorting application may be employed for use with a nested logit model to generate nests based on user data rather than rely upon analyst judgment.

Returning to FIG. 9, the example substitutability matrix engine 204 is invoked after the card sort to create a matrix of substitutability based on the groupings created by the respondents (block 904). For example, if the marketing study includes fifty products of interest, then the example substitutability matrix engine 204 will generate a 50 by 50 triangular matrix having 50 rows (i) and 50 columns (j). Each time the respondent groups a first item to a second item (i.e., creating a pair), the corresponding matrix element representing the pair is incremented. The matrix represents a proximity between pairs of products for the entire study in which the highest value matrix cells are indicative of pairs of products deemed most similar by the respondents. The highest value possible for any cell is the total number of respondents, thus, the matrix diagonal will have a value equal to the total number of respondents.

In the event that a respondent groups together all of the products, they will ultimately increment each matrix cell by one because all possible pairs of products are grouped together. On the opposite extreme, in the event that a respondent groups each product in its own group, then the matrix cells will just add one to the diagonal terms of the matrix. Further still, if a respondent creates two groups, one with three products and one with the 47 remaining products, the degree of items substitutability in the small group may be considered greater, while circumstances where the respondent groups all the products together illustrate group equality. These disparities may be addressed by way of matrix normalization for each respondent, and application of a weight of pairs of products based on the number of items in the group. As such, when a group is larger, the corresponding items within that group are less substitutable to each other than a smaller group of the set. In other words, larger groups represent products that are less substitutable and a lower normalization value may be applied to the values of larger groups. The weight of each group is based on the number of products contained therein in a manner consistent with example Equations 4 and 5.

$$\begin{matrix}\frac{1}{Ng} * \frac{1}{( {\sum }_{g} \frac{Ng - 1}{2} ) + n} . & Equation 4 \\ \frac{1}{( {\sum }_{g} \frac{Ng - 1}{2} ) + n} . & Equation 5\end{matrix}$$

In the example Equations 4 and 5, Ng represents a number of products in group (g) and N represents a total number of products. The group weight is represented in example Equation 4 as 1/Ng followed by a normalization term. Example Equation 4 is for two products in the same groups, while example Equation 5 is for one product for diagonal terms. In the event there are two products in different groups, the normalization is zero.

Group weight represents the circumstances where larger groups are composed of products that are less substitutable to each other, and the normalization term provides for the addition of one point throughout the matrix for each respondent. In other words, the normalization term makes all respondents equally weighted. Matrices may be constructed using any software and/or statistical application including, but not limited to Statistical Analysis System (SAS) software packages provided by the SAS Institute, Inc.®.

The example multidimensional scaling engine 206 performs a multidimensional scaling (MDS) operation on the matrix to generate a map of products based on their proximities in terms of proximity (block 906). The more substitutable two items are, the closer they will be placed on the map. The output of MDS includes coordinates of all the products in an N-dimensional space. The example MDS scaling engine 206 may employ the Statistical Package for the Social Sciences (SPSS) and/or, more specifically, proximity scaling (PROXSCAL) with a Simplex starting value for MDS distance model scaling. However, any type of starting value may be employed as needed, such as, but not limited to a Torgerson or a Single Random Start method. The Simplex starting method initially places all the products equidistant and then attempts to improve an indicator of the goodness of fit, sometimes referred to as a stress value, by changing distances between products.

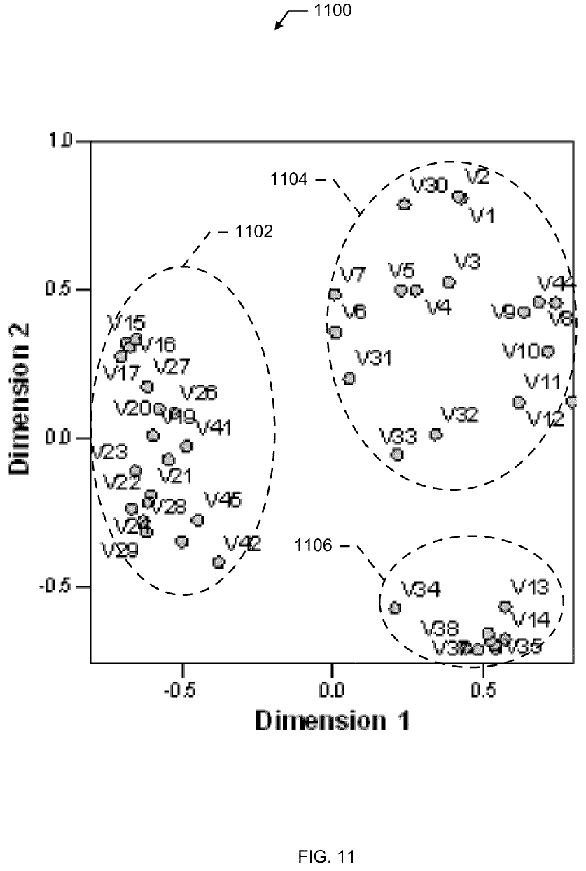

FIG. 11 is an example MDS map of an unweighted matrix of products substitutability 1100. The example map 1100 illustrates a first cluster 1102, a second cluster 1104 and a third cluster 1106. To specify a number of dimensions to use with MDS analysis, Scree plots reveal stress values. Generally speaking, a lower stress value corresponds to a lower distortion in which stress values less than approximately 0.1 are considered good, and stress values greater than approximately 0.15 are considered bad. The Scree plot represents the normalized raw stress for different dimension values. Keeping the number of selected dimensions small allows for greater ease of result interpretation, but enough dimensions are helpful for maintaining enough information to minimize distortion.

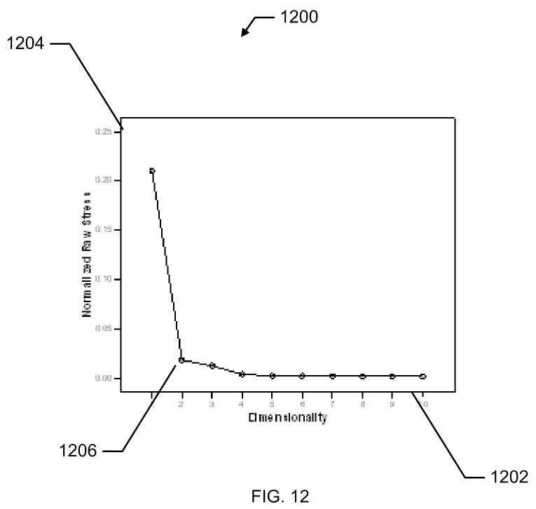

FIG. 12 is an example Scree plot 1200. In the illustrated example of FIG. 12, the plot 1200 includes an x-axis representative of a number of dimensions 1202 and a y-axis representative of the normalized raw stress 1204. The plot 1200 also includes an elbow 1206, which illustrates that using two dimensions allows the corresponding normalized raw stress to remain relatively low.

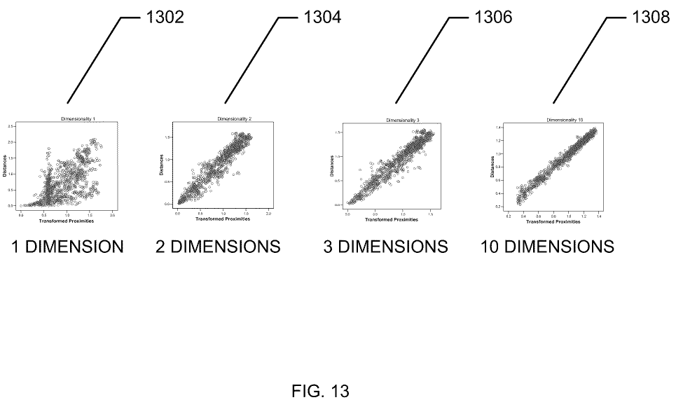

In some examples, the MDS engine 206 generates residual plots to confirm whether an appropriate number of dimensions is selected. FIG. 13 illustrates a residual plot representative of one dimension 1302, a residual plot representative of two dimensions 1304, a residual plot representative of three dimensions 1306, and a residual plot of ten dimensions 1308. In the illustrated example of FIG. 13, the residual plot of one dimension 1302 reveals significant distortion, but dimension values greater than one reveal lower distortion.

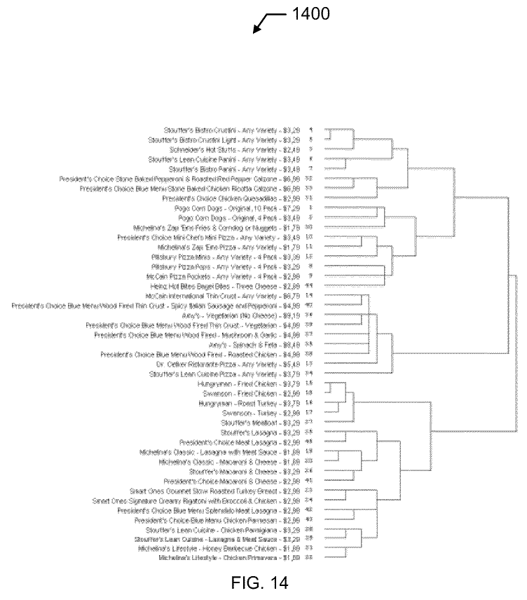

Returning to FIG. 9, the example cluster analysis engine 208 is invoked to perform a cluster analysis on the map cluster data. The cluster analysis engine 208 may create a hierarchical tree to allow further analysis of the suitability of the clusters identified by the example MDS map 1100 of FIG. 11. FIG. 14 is an example hierarchical tree 1400 generated by the example cluster analysis engine 208. In the illustrated example of FIG. 14, the tree 1400 reveals cluster groupings and subgroupings. To determine the number of clusters with which to proceed in a virtual shopping trip, the example tree 1400 is analyzed for consistency of intra-cluster proximities and inter-cluster distances. Hierarchical clustering starts with each product in its own cluster and calculates all inter-cluster distances. Each of the product pairs that are closest to each other are grouped together, and the process iterates until all products are paired. A Euclidian distance may be used to represent the distance between each product within its own cluster. Distances between clusters, on the other hand, may be calculated via, for example, Between-Group linkage techniques, Within-Group linkage techniques and Wards techniques, without limitation. The Between-Group linkage technique calculates the distance between two clusters as an average distance between all inter-cluster pairs, while the Within-Groups linkage techniques (also referred to as “average linkage within groups”) uses a mean distance between all possible inter-cluster or intra-cluster pairs. The Wards techniques uses an analysis of variance approach to select the two closest clusters and minimizes the sum of squares any pair of clusters formed. Generally speaking, the tree 1400 can reveal if the clusters maintain a logical relationship with similar products consumers might find at a retail establishment.

After selecting a number of clusters with which to proceed (e.g., 3 clusters, 5 clusters, etc.), the example program 900 calculates substitutability across subcategories (block 910). The calculation is an estimated measure of the degree of substitutability between subcategories with MDS coordinates from the products. Calculated distances are relative to each other rather than based on an absolute value or metric. As such, the example substitutability manger 108 may calculate percentage values to identify how substitutable one product is to another product. For example, a pair of candidate products of pads versus tampons having a substitutability factor of 60% means that pads are more substitutable than tampons relative to a substitutability metric of 50%. In the event that the factor was 0%, then pads are never substitutes for tampons. On the other hand, in the event that the factor was 100%, then pads are as much a substitute as a tampon. Choice shares are calculated (block 912) based on the substitutability information (block 910) and base choice probability values (block 312).

While the MDS analysis in the manner described above facilitates implementation of MNL models in a manner that considers substitutability when calculating choice probability, the MDS analysis may be computationally intensive in some circumstances. Another example manner of calculating choice probabilities in view of product substitutability is described below that avoids the MDS analysis.

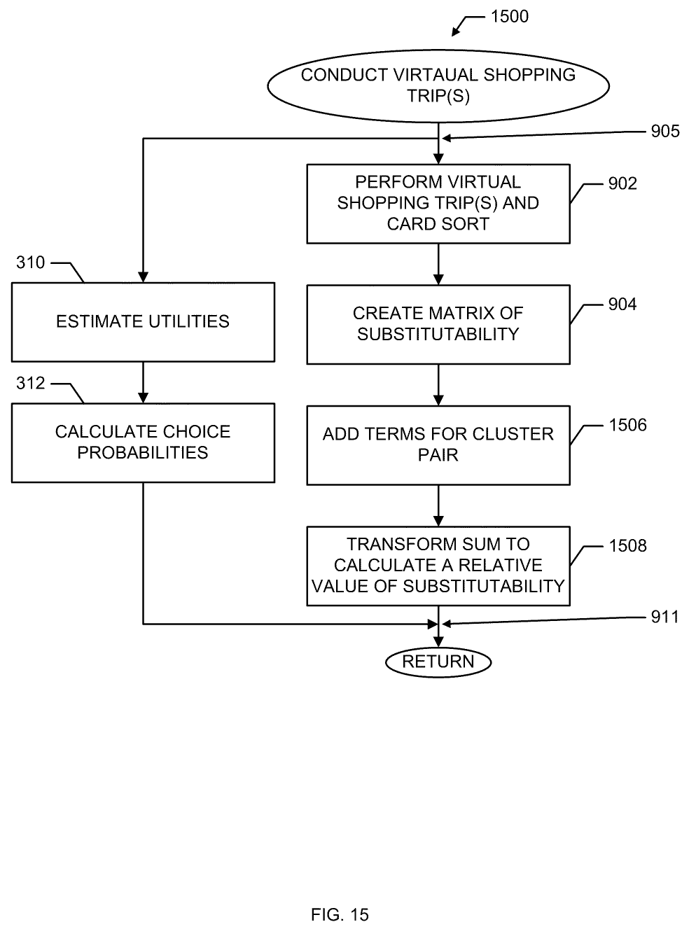

FIG. 15 is an example program 1500 to conduct virtual shopping trips in a manner that allows the program of FIG. 3 to operate without MDS analysis. The example program 1500 of FIG. 15 may be, in whole or in part, substituted for block 308 of FIG. 3 and includes similar functions to perform one or more virtual shopping trip(s) and a card sort (block 902) and create a matrix of substitutability (block 904) as described in view of FIG. 9. Additionally, the example program 1500 may proceed in a parallel manner with blocks 310, 312 in parallel with blocks 904, 1506 and 1508 before rejoining at node 911. Generally speaking, the program 1500 of FIG. 15 calculates a degree of substitutability across subcategories using the matrix of items substitutability.

Table 1 below is an example matrix of products substitutability having seven (7) example items/products, which may be generated by the example substitutability matrix engine 204 in a manner as described in view of block 904 of FIG. 9.

TABLE 1

| | | | | | | | Item |
|---|---|---|---|---|---|---|---|
| | Item 1 | Item 2 | Item 3 | Item 4 | Item 5 | Item 6 | 7 |
| Item 1 | 500 | | | | | | |
| Item 2 | 150 | 500 | | | | | |
| Item 3 | 201 | 203 | 500 | | | | |
| Item 4 | 254 | 401 | 211 | 500 | | | |
| Item 5 | 397 | 95 | 85 | 139 | 500 | | |
| Item 6 | 122 | 108 | 332 | 88 | 256 | 500 | |
| Item 7 | 97 | 302 | 104 | 259 | 123 | 202 | 500 |

In the illustrated example of FIG. 15, the card sort (block 902) created resulted in a number of clusters and respondent input was used to generate the matrix of table 1 (block 904). One or more clusters may be identified based on a statistical analysis clustering identifier. Cluster 1 from the example data of Table 1 includes items 1 and 5, and cluster 3 from the example data of Table 1 includes items 2, 4 and 7. To create a degree of substitutability between clusters 1 and 3, the example substitutability matrix engine 204 adds all the terms of the matrix of products that correspond to the pairs of products for which one item is in cluster 1 and the other item is in cluster 3 (block 1506). This corresponds to pairs of products 1 and 2, 1 and 4, 1 and 7, 5 and 2, 5 and 4, and 5 and 7. The sum of these pairs (i.e., 150+254+97+95+139+123) is 858. The example substitutability matrix engine 204 divides the sum by the number of pairs of products considered (i.e., 6 for this example), and divides that by the total number of respondents (i.e., 500 for this example) (block 1508). As such, the measure of substitutability across subcategories is equal to 0.29, and the matrix of products substitutability may be represented as shown in Table 2.

TABLE 2

| | | | | | | | Item |
|---|---|---|---|---|---|---|---|
| | Item 1 | Item 2 | Item 3 | Item 4 | Item 5 | Item 6 | 7 |
| Item 1 | 100% | | | | | | |
| Item 2 | 30% | 100% | | | | | |
| Item 3 | 40% | 40% | 100% | | | | |
| Item 4 | 50.1% | 80% | 42% | 100% | | | |
| Item 5 | 79% | 19% | 17% | 28% | 100% | | |
| Item 6 | 24% | 22% | 66% | 18% | 51% | 100% | |
| Item 7 | 19% | 60% | 21% | 52% | 25% | 40% | 100% |

The calculated measures of substitutability as described above avoid the use of MDS analysis, thereby improving process simplicity, reducing computational burdens, and improving result accuracy because results are not dependent upon a number of dimensions with which to proceed.

The example tables may be used to illustrate a measure of substitutability across a number of clusters using the results from the product/item substitutability values. Table 3 below illustrates measures of substitutability when three clusters are chosen.

TABLE 3

| | subcategory 1 | subcategory 2 | subcategory 3 |
|---|---|---|---|
| subcategory 1 | 100% | 24.18% | 23.16% |
| subcategory 2 | 24.18% | 100% | 21.01% |
| subcategory 3 | 23.16% | 21.01% | 100% |

In the illustrated example of Table 3, the degree of substitutability across clusters is almost the same for all the pairs of clusters. In particular, 21.01% represents the degree of substitutability for clusters 2 and 3, and 24.18% represents the degree of substitutability for clusters 1 and 2. Table 4 below illustrates measures of substitutability when four subcategories are chosen.

TABLE 4

| | sub 1 | sub 2 | sub 3 | sub 4 |
|---|---|---|---|---|
| sub 1 | 100% | 36.42% | 24.82% | 19.01% |
| sub 2 | 36.42% | 100% | 23.47% | 27.84% |
| sub 3 | 24.82% | 23.47% | 100% | 21.01% |
| sub 4 | 19.01% | 27.84% | 21.01% | 100% |

In the illustrated example of Table 4, subcategory 1 represents snack food, subcategory 2 represents single serve sandwiches, subcategory 3 represents multi serve pizza, and subcategory 4 represents single serve meals. The first two subcategories are most substitutable to each other with a degree of substitutability of 36.42%, and the next closest groups are subcategories 2 and 4. The closeness of subcategories 2 and 4 makes sense because, in part, they are both composed of single serve portion products.

Table 5 below illustrates measures of substitutability when five subcategories are chosen.

TABLE 5

| | sub 1 | sub 2 | sub 3 | sub 4 | sub 5 |
|---|---|---|---|---|---|
| sub 1 | 100% | 36.42% | 24.82% | 21.09% | 18.27% |
| sub 2 | 36.42% | 100% | 23.47% | 25.01% | 28.85% |
| sub 3 | 24.82% | 23.47% | 100% | 17.72% | 22.19% |
| sub 4 | 21.09% | 25.01% | 17.72% | 100% | 44.47% |
| sub 5 | 18.27% | 28.85% | 22.19% | 44.47% | 100% |

In the illustrated example of Table 5, the fourth and fifth subcategories represent meals made primarily with meat and primarily made with pasta, respectively. Accordingly, these are the closest groups, which were previously gathered together in example Table 4 as single serve meals.

Using one or more tables of category proximities (measures of substitutability), original respondent utilities and respondent probabilities may be provided to the example cross sourcing engine 210 to generate modified utilities and calculate the probability of choosing any item in a subcategory when products are not 100% substitutable. While the above examples describe creating a single substitutability matrix that is applied to one or more choice share calculations, the methods and apparatus described herein are not limited thereto. In other words, instead of creating one matrix that covers the entire respondent pool, some examples include one matrix may be generated for each individual respondent, and/or a matrix based on one or more clusters of respondents. Respondent clusters may be based on any parameters, such as by respondent demographic characteristics and/or based upon clustered responses to the card sort exercise(s). An example segmented substitution matrix may be generated, in which the consumer segments are derived based on a similarity of their overall substitution results. That is, the input for the segmentation of consumers may include individual segmentation matrices.

Additionally or alternatively, one or more combinations of matrices may be employed with the methods and apparatus described herein. For example, an overall matrix for the entire respondent group may be generated, as described above, combined with one or more matrices based on respondent clusters, and/or combined with a matrix based on a single respondent. At least one benefit to the one or more combinations of matrices includes tailoring market studies to a level of geographical, demographical and/or product-based granularity. For example, a multi-subcategory study may reveal differing results based on the homogeneity of the respondents, the homogeneity of the available products, etc. As such, tailoring one or more sub-matrices and/or applying functional weights may reveal additional market granularity. Each of the matrices may be implemented as a function (e.g., linear function) that is weighted. As described above, each matrix provides an indication of the relative distance/closeness between products.

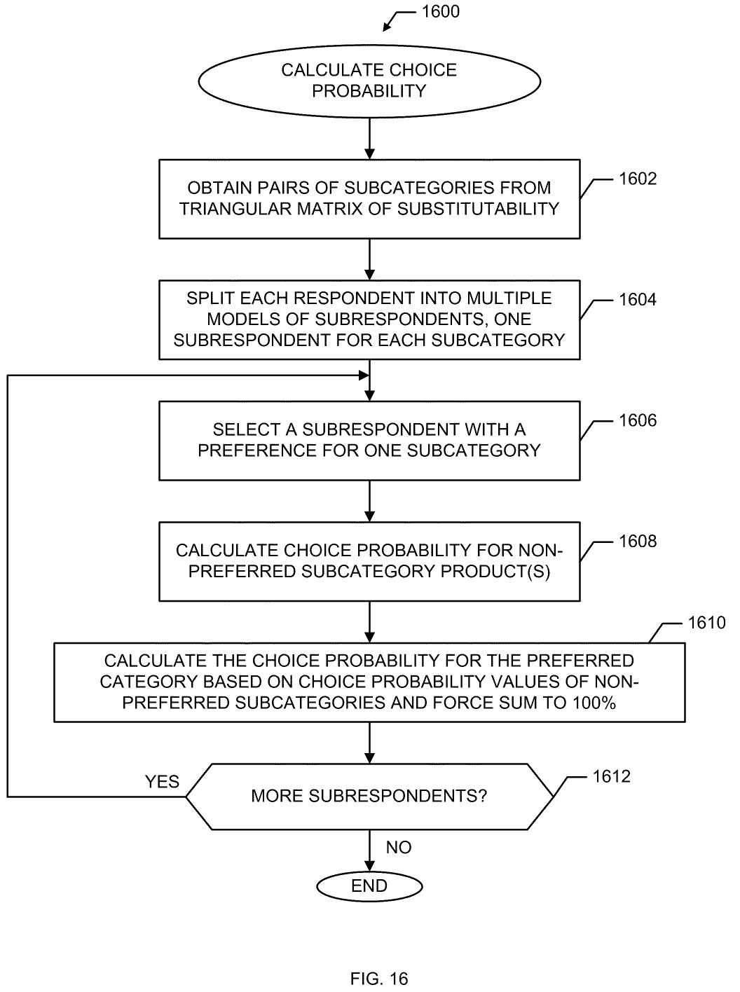

FIG. 16 is an example program 1600 to calculate choice probabilities based on products that are not 100% substitutable. The example program 1600 of FIG. 16 may be substituted for block 312 of FIG. 3 to calculate choice probabilities, or continue from the example program 1500 of FIG. 15. In the illustrated example of FIG. 16, the cross sourcing engine 210 obtains and/or otherwise receives pairs of subcategories from one or more triangular matrices of substitutability (block 1602). Each respondent is split into a number of subrespondents based on the number of subcategories from the example matrix of substitutability (block 1604). Each of the subrespondents will differ in that one subrespondent will have a primary preference for one of the subcategories, and a lesser preference for the remaining subcategories. One subrespondent having a preference for a subcategory is selected (block 1606) and a choice probability is calculated for the remaining subcategories that are not associated with the selected preferred subcategory (block 1608). Based on the choice probability values for the non-preferred subcategories, a choice probability for the preferred subcategory is calculated in a manner that forces the sum of all subcategories (preferred and non-preferred) to equal 100% (block 1610). In the event that there are more subrespondents (block 1612), control returns to block 1606 to iterate through and/or process another subrespondent.

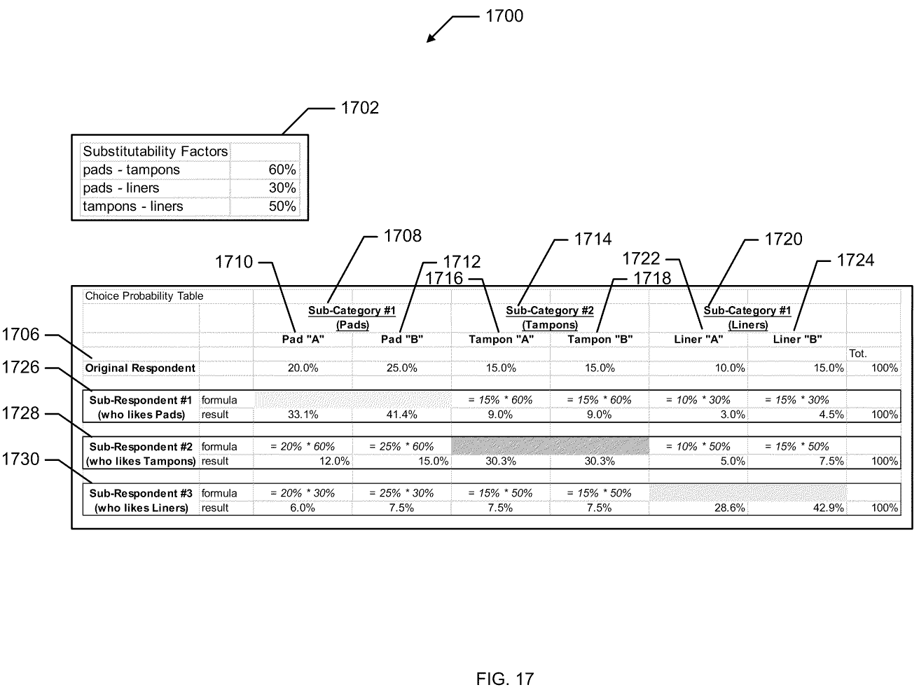

FIG. 17 is an example substitutability choice probability output 1700 of the example program 1600 of FIG. 16. In the illustrated example of FIG. 17, baseline substitutability factors from a substitutability matrix are received 1702. Example products of interest for the example output 1700 include feminine hygiene products of pads, tampons and liners. Generally speaking, if a substitutability factor is 0%, then a first product is never considered a substitute for a second product, however if a substitutability factor is 100%, then a first product is always considered a substitute for a second product. In other words, the substitutability factor is a relative sliding scale. For the pair of products pads and tampons, the example substitutability factor is 60%, which indicates that the two subcategories have a relative degree of substitutability to each other. However, for the pair of products pads and liners, the example substitutability factor is 30%, which indicates that pads are not a likely substitute for liners in the opinion of the respondent.

An example choice probability table 1704 includes the original respondent 1706 and the corresponding choice probability values for a first subcategory associated with pads 1708, which includes two types of pads products; pad “A” 1710 and pad “B” 1712. The example choice probability table 1704 also includes a second subcategory associated with tampons 1714, which includes two types of tampon products; tampon “A” 1716 and tampon “B” 1718. The example choice probability table 1704 also includes a third subcategory associated with liners 1720, which includes two types of liner products; liner “A” 1722 and liner “B” 1724.

As described above in connection with FIG. 16, because there are three subcategories, the example cross sourcing engine 210 generates three corresponding subrespondents, one having a primary preference (primary product) for each one of the three subcategories. The example choice probability table 1704 includes a first subrespondent 1726 that prefers pads, a second subrespondent 1728 that prefers tampons, and a third subrespondent 1730 that prefers liners. Based on the substitutability matrix information, the example original respondent has corresponding original choice probability values for each of the products in each of the subcategories, in which each corresponding choice probability is not necessarily equal to the others, but all add up to 100%. The methods and apparatus described herein also calculate choice probability values for each of the subrespondents based on the substitutability factors and the original choice probability values of the respondent. In other words, the subrespondents behave like alternate personalities of the respondent and reflect remaining permutations of preferences for the subcategories.

In the illustrated example of FIG. 17, the first subrespondent 1726 prefers pads (e.g., the primary product), but tampons and liners are preferred to a lesser degree (e.g., secondary products). The corresponding choice probability for tampon “A” 1716 is calculated based on the product of the original choice probability (i.e., 15%) and the respondent's substitutability factor related to pads and tampons (i.e., 60%) to yield 9%. Remaining product choice probability values for the remaining subcategories are calculated before calculating the choice probability values for the first subrespondent 1726 associated with pads. Example Equation 6 illustrates a manner of calculating the choice probability.

$$CP = \frac{{P}_{Orig}}{{P}_{Sum}} * ( 1 - \sum {P}_{NonPref} ) . \qquad Equation 6$$

In the illustrated example of Equation 6, CP is the choice probability, P_{Orig} is the choice probability for the product of interest within the primary subcategory of interest, P_{Sum} is the sum of choice probabilities for all products within the primary subcategory, and P_{NonPref} is the sum of choice probabilities for the remaining products not associated with the primary subcategory. Example Equation 7 illustrates Equation 6 with values associated with the first subrespondent 1726 for the products within the first subcategory 1708.

$$CP = \frac{20 \%}{( 20 \% + 25 \% )} * ( 1 - 9 \% - 9 \% - 3 \% - 4.5 \% ) . \qquad Equation 7$$

The remaining choice probabilities are calculated in a similar manner as described above.

As described above, the example cross sourcing engine 210 receives a number of subcategories having a degree of substitutability to each other, which is represented as a percentage of substitutability for each subcategory pair. The substitutability values may be entered into a matrix labeled CrossMat, which is a G by G triangular matrix, in which G represents a number of subcategories and the values correspond to the substitutability between the subcategories. For each respondent r, CrossMat may be modified as shown by example Equation 8.

Σ_{g=1}^{G}Probᵣ(g)*CrossMat_{g,k}^{r}=1 Equation 8.

In the illustrated example of Equation 8, k and g represent two subcategories and Probᵣ(g) represents the aggregate probability that respondent r chooses any item within the subcategory g. When modifying CrossMat to form CrossMatᵣ, the change can be made to appear only on the diagonal terms of the matrix by way of example Equation 9.

$${CrossMat}_{g , g}^{r} = \frac{1 - {\sum }_{k = 1 … G , k \neq g} {CrossMat}_{g , k}^{r} * {Prob}_{r} ( k )}{{Prob}_{r} ( g )} . \qquad Equation 9$$

The original utilities u from the respondent r for item i (uᵣᵢ) are modified by the example cross sourcing engine 210 to improve sourcing and volume estimations in a multi-category study. As described above, each original respondent r is converted into a number of subrespondents equal to the number of subcategories G. For each subrespondent r_{g}, the new utility uᵣᵢ is defined in a manner shown by example Equation 10.

Uᵣ_{_{g}}ᵢ=uᵣᵢ+ln(CrossMat_{g,k}^{r})

where iεk and g, kε[1 . . . G] Equation 10.

In the illustrated example of Equation 10, the utility (U_{rgi}) of respondent r_{g} for an item i is increased, and utilities for remaining items in other subcategories are decreased. The example manner of modifying utilities also modifies the corresponding probabilities of choosing any item in a subcategory. Example Equation 11 illustrates the original probability calculation when employing the logit model.

$${Prob}_{r} ( g ) = \frac{{\sum }_{i ∈ g} {exp}^{{u}_{ri}}}{{\sum }_{k = 1}^{G} {\sum }_{i ∈ k} {exp}^{{u}_{ri}}} . \qquad Equation 11$$

When considering the modified CrossMatᵣ, as described above in view of Equation 9, the new probabilities are represented by example Equation 12.

$$\begin{matrix}{Prob}_{{r}_{k} ( g )} = \frac{{\sum }_{i ∈ g} {exp}^{{u}_{rki}}}{{\sum }_{l = 1}^{G} {\sum }_{i ∈ l} {exp}^{{u}_{rki}}} \\ = \frac{{\sum }_{i ∈ g} {exp}^{{u}_{ri} + ln ( {CrossMat}_{k , g}^{r} )}}{{\sum }_{k = 1}^{G} {\sum }_{i ∈ k} {exp}^{{u}_{ri} + ln ( {CrossMat}_{k , g}^{r} )}} \\ = \frac{{CrossMat}_{k , g}^{r} {\sum }_{i ∈ g} {exp}^{{u}_{ri}}}{{\sum }_{k = 1}^{G} {\sum }_{i ∈ k} {CrossMat}_{k , g}^{r} {exp}^{{u}_{ri}}} .\end{matrix} \qquad Equation 12$$

By imposing the constraints of example Equation 8, example Equation 12 may be represented by example Equation 13.

$${\sum }_{g = 1}^{G} \frac{{\sum }_{i ∈ g} {exp}^{{u}_{ri}}}{{\sum }_{k = 1}^{G} {\sum }_{i ∈ k} {exp}^{{u}_{ri}}} * {CrossMat}_{g , k}^{r} = \frac{1}{{\sum }_{k = 1}^{G} {\sum }_{i ∈ k} {exp}^{{u}_{ri}}} * {\sum }_{g = 1}^{G} {\sum }_{i ∈ g} {exp}^{{u}_{ri}} * {CrossMat}_{g , k}^{r} = 1. \qquad Equation 13$$

Example Equation 13 simplifies to example Equation 14.

$${\sum }_{g = 1}^{G} {\sum }_{i ∈ g} {exp}^{{u}_{ri}} * {CrossMat}_{g , k}^{r} = {\sum }_{k = 1}^{G} {\sum }_{i ∈ k} {exp}^{{u}_{ri}} . \qquad Equation 14$$

When example Equation 14 is integrated for Probᵣₖ(g), example Equation 15 results.

$$\begin{matrix}{Prob}_{{r}_{k} ( g )} = \frac{{CrossMat}_{k , g}^{r} {\sum }_{i ∈ g} {exp}^{{u}_{ri}}}{{\sum }_{k = 1}^{G} {\sum }_{i ∈ k} {exp}^{{u}_{ri}}} \\ = {CrossMat}_{k , g}^{r} * {Prob}_{r} ( g ) .\end{matrix} \qquad Equation 15$$

The example cross sourcing engine 210 applies a weight w(r_{g}) for each subrespondent r_{g} to follow the example rules of example Equations 16 and 17.

$$\begin{matrix}{\sum }_{g = 1}^{G} w ( {r}_{g} ) = 1 , for every respondent r . & Equation 16 \\ {Prob}_{r} ( g ) = {\sum }_{k = 1}^{G} w ( {r}_{k} ) * {Prob}_{rk} ( g ) . & Equation 17\end{matrix}$$

The rule of example Equation 16 imposes that all the original respondents have unit weight after the utilities modification. The rule of example Equation 17 prevents probability changes for respondents that buy a product within a particular subcategory such that, for a base scenario in which all products are available, the overall probability of a respondent to choose one category is the same.

FIG. 18 is a block diagram of an example computer P100 capable of executing the instructions of FIGS. 3, 9, 15 and 16 to implement the apparatus of FIGS. 1 and 2. The computer P100 can be, for example, a server, a personal computer, or any other type of computing device.

The system P100 of the instant example includes a processor P105. For example, the processor P105 can be implemented by one or more Intel® microprocessors from the Pentium® family, the Itanium® family or the XScale® family. Of course, other processors from other families are also appropriate.

The processor P105 is in communication with a main memory including a volatile memory P115 and a non-volatile memory P120 via a bus P125. The volatile memory P115 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory P120 may be implemented by flash memory and/or any other desired type of memory device. Access to the main memory P115, P120 is typically controlled by a memory controller (not shown).

The computer P100 also includes an interface circuit P130. The interface circuit P130 may be implemented by any type of interface standard, such as an Ethernet interface, a universal serial bus (USB), and/or a PCI express interface.

One or more input devices P135 are connected to the interface circuit P130. The input device(s) P135 permit a user to enter data and commands into the processor P105. The input device(s) can be implemented by, for example, a keyboard, a mouse, a touchscreen, a track-pad, a trackball, isopoint and/or a voice recognition system.

One or more output devices P140 are also connected to the interface circuit P130. The output devices P140 can be implemented, for example, by display devices (e.g., a liquid crystal display, a cathode ray tube display (CRT), a printer and/or speakers). The interface circuit P130, thus, typically includes a graphics driver card.

The interface circuit P130 also includes a communication device (not shown) such as a modem or network interface card to facilitate exchange of data with external computers via a network (e.g., an Ethernet connection, a digital subscriber line (DSL), a telephone line, coaxial cable, a cellular telephone system, etc.).

The computer P100 also includes one or more mass storage devices P150 for storing software and data. Examples of such mass storage devices P150 include floppy disk drives, hard drive disks, compact disk drives and digital versatile disk (DVD) drives. The mass storage device P150 may implement the local storage device.

The coded instructions P110, P112, such as the instructions of FIGS. 3, 9, 15 and 16 may be stored in the mass storage device P150, in the volatile memory P115, in the non-volatile memory P120, and/or on a removable storage medium such as a CD or DVD.

From the foregoing, it will appreciate that the above disclosed methods, apparatus and articles of manufacture address the issues related to the Independence of Irrelevant Alternatives, in which traditional approaches to choice modeling using the MNL model are unsuccessful.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to calculate choice probability, comprising:
receiving base choice probability values for a respondent, wherein the base choice probability value is associated with a product;
receiving a respondent substitutability factor associated with the product;
identifying, with a cluster analysis engine, a primary product and a secondary product and generating a subrespondent associated with the secondary product; and
calculating, with a cross sourcing engine, a modified choice probability for the subrespondent for the secondary product based on the respondent substitutability factor and the base choice probability values associated with the secondary product.

2. A method as described in claim 1, further comprising calculating a modified choice probability for the subrespondent for the primary product based on the base choice probability values associated with the primary product and the modified choice probability of the secondary product.

3. A method as described in claim 1, wherein the primary product and the secondary product are associated with a common category and different subcategories.

4. A method as described in claim 1, further comprising performing a card sort to obtain information indicative of substitutability between the primary product and the secondary product.

5. A method as described in claim 4, further comprising generating a triangular matrix with the information indicative of substitutability to calculate a relative similarity distance between the primary product and the secondary product.

6. A method as described in claim 1, further comprising performing a virtual shopping exercise using a multinomial logit model to generate the base choice probability values.

7. A method to calculate choice probability, comprising:
performing a card sort for products within a category using a card sort engine, the card sort engine retrieving information indicative of product similarity;
generating, with a substitutability matrix engine, a triangular matrix with the information indicative of product similarity;
transforming the triangular matrix into a list of product subcategories;
calculating substitutability values between the subcategories based on matrix values for pairs of products selected between product subcategories; and
invoking a multinomial logit model to generate choice probabilities based on the substitutability values and a virtual shopping exercise.

8. A method as described in claim 7, wherein the triangular matrix increments a product pair cell value in response to a card sort indication of similarity between a first product and a second product.

9. A method as described in claim 8, further comprising adding product pair cell values for each product subcategory pair and dividing by a number of product pairs and a number of respondents to calculate the substitutability values.

10. A method as described in claim 7, wherein invoking the multinomial logit model generates choice probability values based on a degree of substitutability between the product pairs.

11. A method as described in claim 7, wherein the substitutability values suppress independence of irrelevant alternatives.

12. An apparatus to calculate choice probability, comprising:
a card sort engine to generate information indicative of product similarity;
a substitutability matrix engine to generate a triangular matrix with the information indicative of product similarity;
a cluster analysis engine to identify product subcategories within the triangular matrix and calculate substitutability values between the subcategories based on matrix values for pairs of products selected between product subcategories; and
a cross sourcing engine to implement a multinomial logit model to generate choice probabilities based on the substitutability values and a virtual shopping exercise.

13. An apparatus as described in claim 12, wherein the substitutability matrix engine increments a product pair cell value in response to a card sort indication of similarity between a first product and a second product.

14. An apparatus as described in claim 13, wherein the substitutability matrix engine further comprises adding product pair cell values for each product subcategory pair and diving by a number of product pairs and a number of respondents to calculate the substitutability values.

15. An apparatus as described in claim 12, further comprising a discrete choice exercise engine to invoke the virtual shopping exercise.

16. A tangible article of manufacture storing machine readable instructions that, when executed, cause a machine to at least:
receive base choice probability values for a respondent, wherein the base choice probability value is associated with a product;
receive a respondent substitutability factor associated with the product;
identify, with a cluster analysis engine, a primary product and a secondary product and generating a subrespondent associated with the secondary product; and
calculate, with a cross sourcing engine, a modified choice probability for the subrespondent for the secondary product based on the respondent substitutability factor and the base choice probability values associated with the secondary product.

17. A tangible article of manufacture as described in claim 16, wherein the machine readable instructions, when executed, cause the machine to calculate a modified choice probability for the subrespondent for the primary product based on the base choice probability values associated with the primary product and the modified choice probability of the secondary product.

18. A tangible article of manufacture as described in claim 16, wherein the machine readable instructions, when executed, cause the machine to perform a card sort to obtain information indicative of substitutability between the primary product and the secondary product.

19. A tangible article of manufacture as described in claim 18, wherein the machine readable instructions, when executed, cause the machine to generate a triangular matrix with the information indicative of substitutability to calculate a relative similarity distance between the primary product and the secondary product.

20. A tangible article of manufacture as described in claim 18, wherein the machine readable instructions, when executed, cause the machine to perform a virtual shopping exercise using a multinomial logit model to generate the base choice probability values.
